(19) United States
(12) Patent Application Publication
(10) Pub. No.: US 2017/0113357 A1
(43) Pub. Date: Apr. 27, 2017

(54) BLADE DESIGN FOR CUTTING FOOD AND OTHER ITEMS

(71) Applicant: YOGIN P. SUTHAR, White Plains, NY (US)

(72) Inventor: YOGIN P. SUTHAR, White Plains, NY (US)

(21) Appl. No.: 14/922,252

(22) Filed: Oct. 26, 2015

(51) Int. Cl. B26B 3/04; B26D 3/18

(52) U.S. Cl. CPC B26B 3/04; B26D 3/185

(57) ABSTRACT

A cutting device for slicing or chopping food or the like has a plurality of parallel cutting blades, each with a leading cutting edge that is non-linear or even curved from one end to an opposite end thereof and is non-symmetric with respect to a central point between the ends. The leading cutting edge of each blade has a different elevation in the cutting direction than the leading cutting edges of the adjacent blades. With this arrangement the cutting edges of the various blades are caused to slice progressively into the sliceable object and thereby reduce the force required to create the parallel cuts through the object.

### BACKGROUND OF THE INVENTION

The present invention relates to a cutting device for slicing or chopping a sliceable object such as food or the like. More particularly, the present invention concerns the blade design for cutting device of this type.

In the process of food preparation it is often necessary to slice or chop food into small pieces. This type of cutting is not limited to food and may also apply to non-food items that have a similar consistency. A number of devices exist for this purpose. A popular food chopper is disclosed in the Kaposi U.S. Pat. No. 7,762,169. Kaposi provides a flat grid of blades and a hinged lid for pressing food downward against the blades. A food reservoir is arranged beneath the blades to catch the chopped food parts. One practical shortcoming of this known device, and with similar food cutting devices, lies with the excessive amount of force necessary to press the food item through the grid of blades. Not only does this excessive force make cutting difficult for the user, but it can exceed the mechanical limits of the hinged lid, which is often made of plastic, resulting in damage to the device.

Other food cutting devices, such as those shown in the Cohn et al. U.S. Pat. No. 2,166,624; the Heck et al. U.S. Pat. No. 8,205,545; the Kwok Kuen So U.S. Patent Publication No. 2009/0193983; the Miller U.K. Patent No. 2,498,526; the Westland German Utility Model Patent No. 1,943,674 and the Chinese Patent No. 202964717 all employ enhanced blade designs which reduce the blade contact area that cuts into the food item, thereby reducing the amount of force necessary for the blades to penetrate. However, such configurations do not maximize the utility of this concept; that is, the blades simultaneously make contact with the food at multiple points during the cutting process.

Additionally, existing cutting devices, using either a flat or modified grid of blades, do not function to control the position of the food item itself in a manner that prevents it from crushing or from slipping out of the device.

Finally, an item of food is most effectively cut when it is compressed. This is evident when herbs and spices are pressed together before cutting. Existing blade designs do not provide this compression function as they cut.

The standard blade design is sometimes modified with a micro design enhancement while keeping the general configuration the same. For example, Kwok Kuen So's food cutting device (U.S. 2009/0193983) employs a micro design enhancement to a flat grid of blades, whereby the shape of each blade is modified without fundamentally changing the overall flat grid configuration. This provides an incremental improvement but does not substantially reduce the force necessary for cutting.

### SUMMARY OF THE INVENTION

A principal objective of the present invention is to provide a cutting device for a sliceable item, such as a food or the like, that slices, cuts or chops by pressing a plurality of cutting blades against the item.

Another objective of the invention is to provide a cutting device of this type which requires a minimum of force or pressure to effect the cutting with a plurality of blades.

A still further objective of the present invention is to provide a cutting device of this type which restrains the object to be cut during the cutting process.

These objectives, as well as further objectives which will become apparent from the discussion that follows, are achieved, in accordance with the present invention, by providing a cutting device with a plurality of parallel cutting blades, each having a leading cutting edge, wherein cutting edge of each blade is non-linear or even curved from one end to an opposite end thereof and may be non-symmetric with respect to a central point between the ends. In addition, the leading cutting edge of each blade has a different elevation in the cutting direction than the leading cutting edges of the blades adjacent thereto. With this arrangement the cutting edges of the various blades are caused to slice progressively into the sliceable item, thereby reducing the force required to create the parallel cuts through the tem.

Hereinafter, the “sliceable item” may be referred to as “food”, or “a food item”, but it will be understood that the cutting device according to the invention may be used to slice and/or dice other items, such as plastic foam for example.

According to the invention, a leading cutting edge of each blade can be either convex or concave in the cutting direction. In fact, the leading cutting edge of at least some of the blades may be both concave and convex in the cutting direction.

The cutting device may have a single set of parallel blades for slicing the food item, or it may be provided with two sets of parallel cutting blades arranged transversely with respect to each other to make transverse cuts, so as to dice the food. Preferably the two sets of blades form a 90° angle with respect to each other.

The leading cutting edges of either one set of blades, or both sets of blades, may be either convex or concave in the cutting direction. Preferably, however, the leading edges are convex in a first set of blades and concave in the second.

According to a preferred embodiment, the highest elevation of the leading cutting edges in the cutting direction of one set of blades is greater than the highest elevation of the cutting edges in the cutting direction of the other set of blades, thereby allowing the first set of blades to make contact with the food item before contact by the other. This configuration results in a progressive and incremental cutting process. Alternatively, the highest elevations of the two sets of blades may be the same so that the blades cut inward from the outside while simultaneously cutting outward from the inside (e.g. from the center of the cutting device).

With the cutting device so designed and configured, the amount of force required to cut the food item is optimized by requiring the minimum possible effort in starting the penetration of the food item and then increasing the force requirement in an optimally progressive manner. This minimizes the stress on the device as well as on the user.

The blade design also serves to slice or dice the food item in such a way as to prevent crushing and/or slipping from the cutting device. Finally, the design compresses the food item by the nature of the blades' macro shape, providing a beneficial enhancement to the cutting process.

The principal reason that large forces are required to operate prior art cutting devices lies in the fact that often a flat, planar surface of the food item must be urged through a flat, planar surface of the blade grid. The force required to press this item through the set of blades is a maximum in this case where the two meet at a planar surface. The initial penetration of the blades into the food item must occur evenly across the entire flat surface of the em. When a flat surface meets another flat surface, the surface area is a maximum and therefore the maximum amount of force is required for the cuts to penetrate the food item.

A number of cutting devices attempt to address this problem by adjusting the blade design with micro enhancements, such as serrations, to the blades. Serrations provide localized points which help to facilitate initial penetration of the food item. Nevertheless, there are still many such points that must concurrently penetrate the food and, therefore, the design is less than optimal. The existing modifications, at a macro level, still produce an overall blade grid which is substantially flat. An optimum design would provide a perfectly gradual progression of required force, starting with zero force when a single point contacts the food item.

Existing blade designs, in addition to having an overall flat grid basis, are also symmetric about their X and Y axes. Such designs do not restrain or hold the food item in a manner that facilitates cutting. Since cutting is performed in the same manner in all areas of the grid, the food item may be crushed, especially in the case of soft items such as tomatoes, due to the large force that is applied. The asymmetric design of the present invention holds the food in place and counters the crushing or pressing outward action of soft food items.

Existing designs also do not compress the food item in an effective manner. Usually there is a downward force but this force can crush the item and allow it to be squeezed out at the sides of the device, rather than effectively cut. This is especially true with the existing design of Kaposi (U.S. Pat. No. 7,762,169) in which the force required to establish blade penetration into the food item can exceed the item's crush tolerance. The design according to a preferred embodiment of the present invention gradually introduces blades on one (e.g., X) axis into the center of the food item, which produces an expansion of the item and then applies blades from the other (e.g., Y) axis on the outside of the item, thereby also applying an inward pressure on the item. The present invention thus produces bidirectional compression forces which more effectively facilitate the cutting process.

The present invention improves upon existing designs by prescribing a non-planar blade surface that creates localized pressure points on the food item in a progressive manner, for example starting with a single point near the center of the food item. This point progresses to a straight line cut, at which time another point, from another blade, commences penetration which then also becomes a line cut and so on, until several or all of the blades on one axis penetrate the item. While this occurs, blades on the other axis start a similar process from the outside of the food item. The blades that cut from the outside inward also serve the function of keeping the food item contained and prevent its squeezing out of the device due to crushing.

The present invention therefore reduces the amount of force a user must apply to start the process of blade penetration into the food item, no matter what shape the item may have. Additionally, the present invention extends the life of a device of this type by reducing the force repeatedly exerted on the hinge and other components. Finally, the present invention suitably restrains the food item by cutting both from the inside outward and from the outside inward.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a perspective view of the blade design on a cutting device according to a first preferred embodiment of the present invention.

FIG. 2 is diagrammatic view of a flat item of food, showing how the blade design of FIG. 1 results in progressive cutting.

FIG. 3 is a graph showing an example of the force applied to a cutting device with a prior art blade design.

FIG. 4 is a graph showing an example of the force applied to a cutting device with the blade design according to the invention.

FIG. 5 is a graph showing a simplified representation of varying blade elevations for parallel blades in both the X axis and Y axis according to the present invention.

FIGS. 6A and 6B are elevation views of X and Y axis blades having various exemplary designs according to the invention.

FIG. 7 illustrates X and Y axis blades that are non-symmetric with respect to the center point, as a variation of the invention.

FIGS. 8A and 8B show further variations of blade designs according to the invention.

### DESCRIPTION OF THE PREFERRED EMBODIMENTS

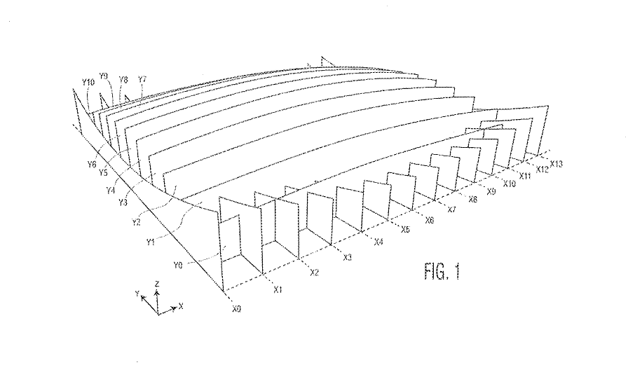

The preferred embodiments of the present invention will now be described with reference to FIGS. 1-8 of the drawings.

FIG. 1 shows a first preferred embodiment of the improved blade design according to the invention, in which there is a grid of non-flat blades along two axes. The blades on the Y axis, with labels Y0 through Y10, are convex with each blade having a peak point on the vertical Z axis. As may be seen, no two Y axis blades are at the same vertical elevation, each blade being slightly higher or lower than its neighboring Y axis blade. This is what allows the incremental penetration of the target item with minimum force, namely, that no two Y axis blades start to penetrate the food item at the same time. The Y axis blades are highest in the center and decrease in the Z axis as they move away from center. Each blade on the Y axis has a single peak point at or somewhat near in the center which commences the blade's penetration into the target item. The center Y axis blade makes the first penetration from among all blades at its peak center point. This point then extends to a line as the blade is pressed into the target item. Afterwards, an adjacent Y axis blade with the next highest Z axis elevation makes its initial penetration at its center peak point which subsequently extends outward and forms a line. This process continues as the target item is urged through the blades.

The penetration of the Y axis blades into the food item causes it to expand due to the width of the blades. This expansion is countered by a compression force caused by the X axis blades pressing on the item as they penetrate the item. Collectively, this compression facilitates the cutting of the target item.

The blades on the X axis, labeled X0 through X13, are concave with each blade having a peak high point at one end and another point at the other end which is at a lower height than the first. This ensures that only one point initiates penetration, thereby minimizing the force required. Each X axis blade dips in the center creating a concave shape.

An adjacent X axis blade has a similar design but with its peak high point at the opposite end from the high point of its neighbors' blades. This ensures a balance in the cutting as half the X axis blades initiate cuts at one end of the grid and the other half initiate cuts at the opposite end of the grid. The two X axis blades at the edges of the grid (X0, X13) are at the same Z axis height. Approaching the center, the blades lower until the center X axis blade which is at the lowest Z axis level. This creates a “bowl” shape which handles the target item by keeping it contained and squeezing it from the outside inward. This squeezing counters the expansion force created by the Y axis blades; the result is a more compressed target item that can more easily be cut.

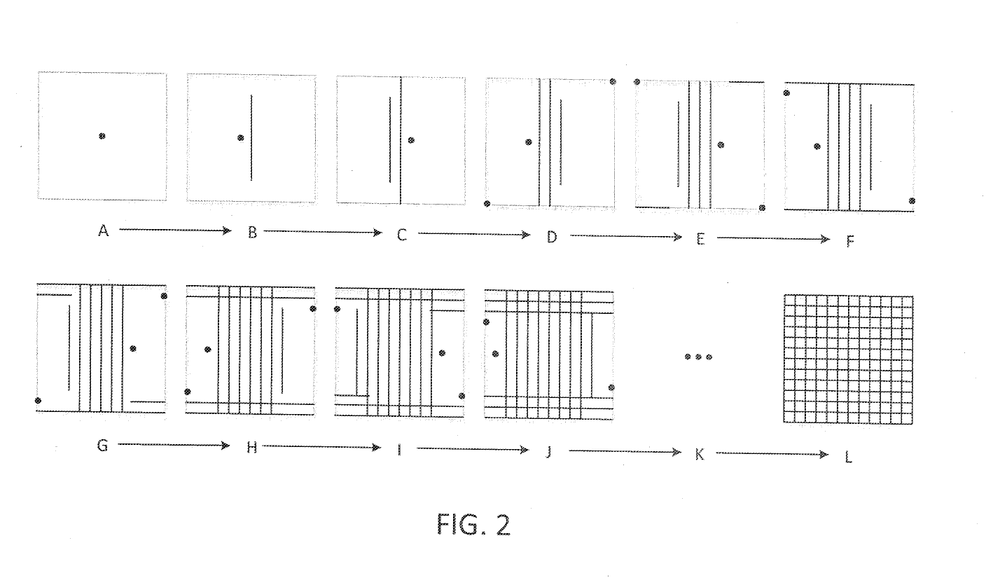

FIG. 2 depicts the pattern in which the target item is cut by the blade design of the current invention. The central Y axis blade first penetrates into the target item starting at a point in the center (FIG. 2, A) which becomes a line as the item is pressed. Thereafter, neighboring Y axis blades cut into the item, each starting at a point and developing into a full line blade cut. The highest X axis blades at each end of the grid then initiate penetration at their peak points (FIG. 2, D), followed by the point at the other end of the blade (FIG. 2, E). These two penetration points then extend to a full line cut (FIG. 2, F). Subsequently, other X axis blades initiate cuts in the same manner which eventually form into full cuts. In all cases, along both axes, blade cuts are initiated at a point and develop gradually into full line cuts.

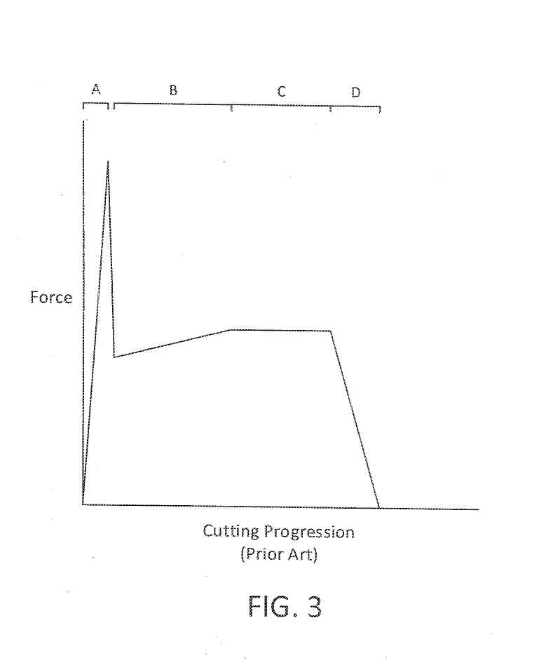

FIG. 3 presents a graph showing the force required to urge a target item through a traditional, prior art blade design—e.g. the blade design shown in the U.S. Pat. No. 7,762,169 to Kaposi—as a function of the item's position as it moves through the cutting process. A target object with a flat bottom, such as a half-onion, is assumed. When the flat part of the half-cut onion is positioned on the blade grid, force is applied and increased until the blades penetrate the surface of the onion. This build up to the peak force is depicted in zone A. After initial penetration is made, the blades penetrate further into the onion. As this happens, the friction increases since more blade surface area is passing through the onion. This increase in force is represented by zone B. This friction increases until it reaches a maximum, then levels off when the blades are fully embedded in the onion. This is represented by zone C. Finally, as the onion exits the blade grid, the force decreases as amount of blade surface area in contact with the onion decreases to zero when the onion fully exits the grid. This is represented by zone D.

Other prior art cutting devices will exhibit a similar force graph. For example, blades with serrations or slight modifications to a substantially flat base, such as Westland German Utility Model No. 1,943,674, will exhibit a slightly more gradual build up to the maximum force in zone A. However, it will not be an optimal force exertion.

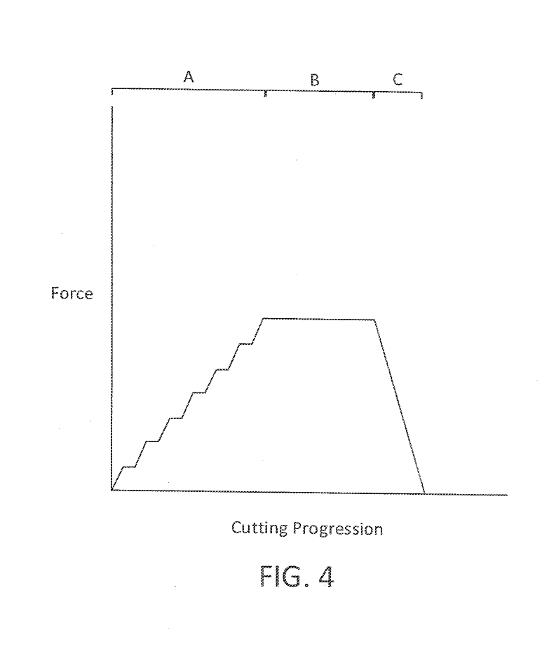

FIG. 4 presents a graph showing the force required to urge a target item through the blade design of the current invention, as a function of the item's position as it moves through the cutting process. A target object with a flat bottom such as a half-onion, is assumed. When the flat part of the half-cut onion is positioned on the blade grid, the first blade makes initial penetration at a single point (the center point of the center Y axis blade). This requires a minimum force. As the item is urged further, additional blades incrementally make cuts into the object. This process requires an incrementally increasing force as each blade sequentially penetrates the item. This is represented by zone A. This force increases to a maximum and levels off when all blades are completely embedded in the item. This is represented by zone B. Finally, as the onion exits the blade grid, the force decreases as the amount of blade surface area in contact with the onion decreases to zero when the onion fully exits the grid. This is represented by zone C.

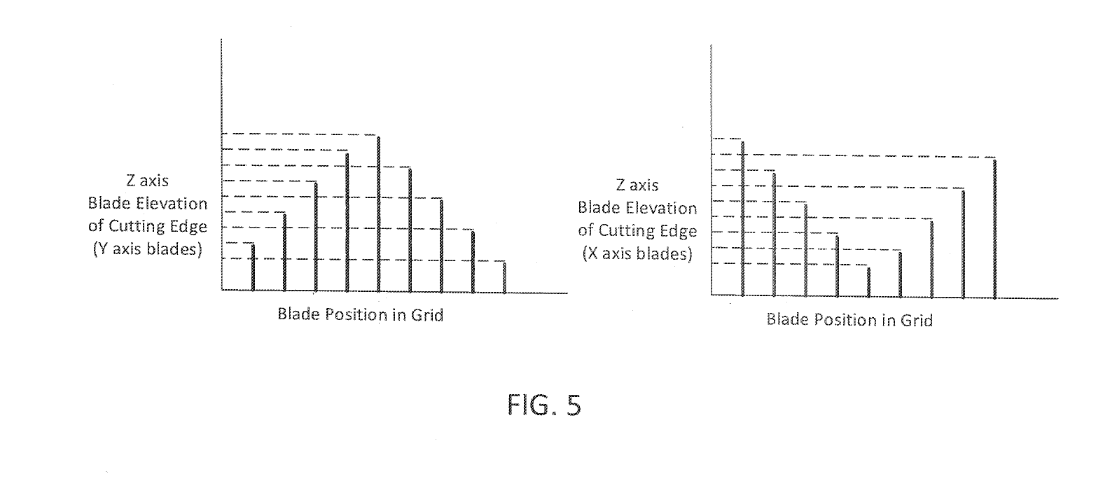

FIG. 5 is a representational diagram showing the blades on each axis in side view. As may be seen, no two blades have the same elevation. This feature of the invention allows an incrementally increasing force to be applied to cut the target item. The left image of the figure represents the Y axis blades and the right image represents the X axis blades of FIG. 1.

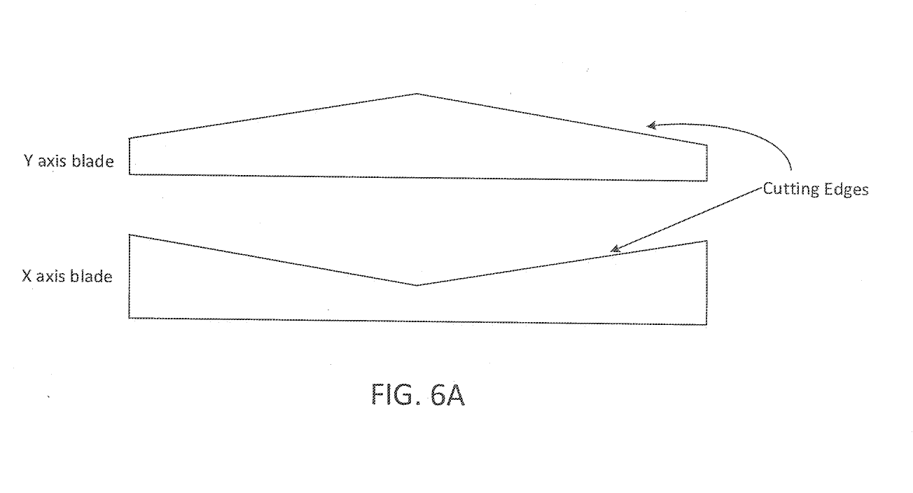

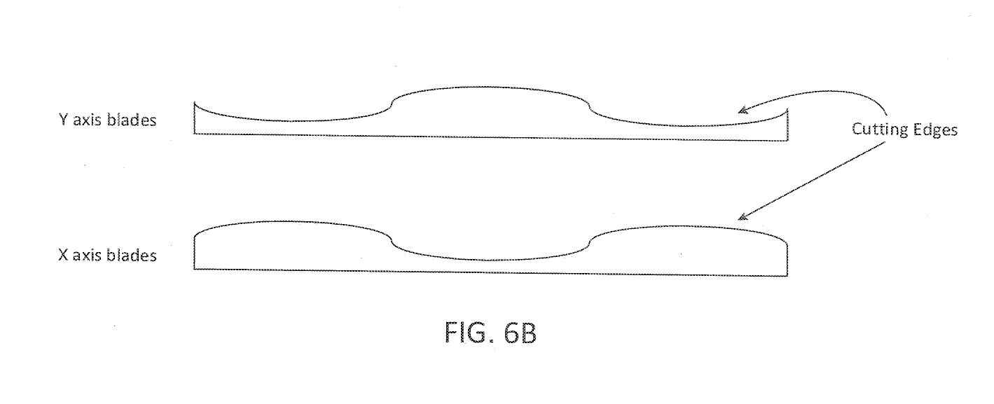

FIG. 6A presents one variation of the X and Y axis blade design in which the edges have linear components but, overall, still possess concave and convex properties.

FIG. 6B presents another variation of the X and Y axis blades in which the edges possess both convex and concave properties.

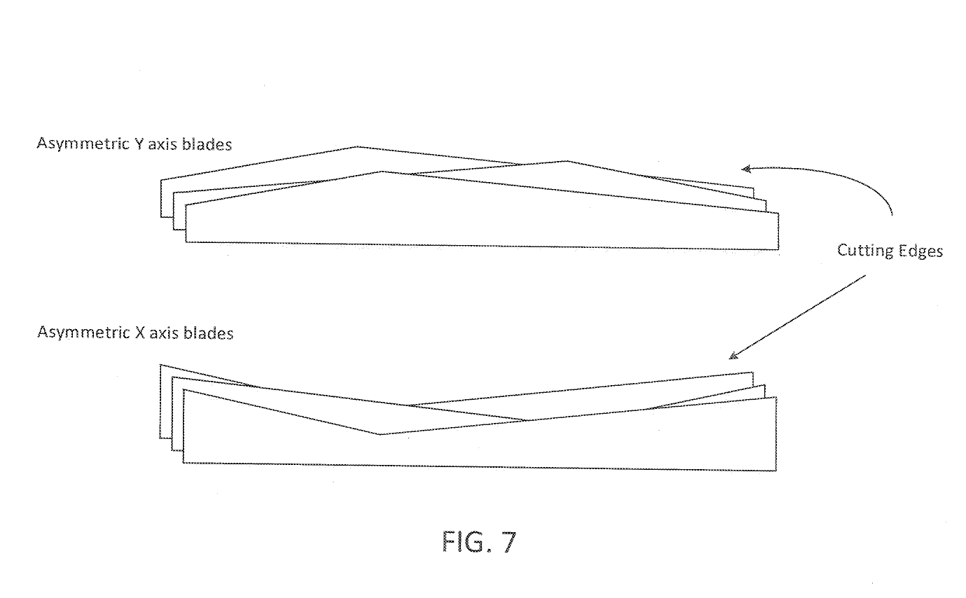

FIG. 7 presents a blade design in which the blades are non-symmetric with respect to a center point of the cutting device.

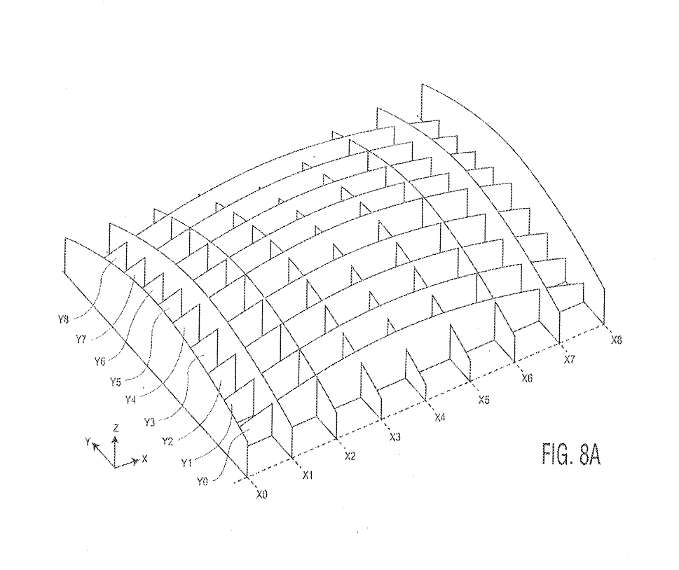

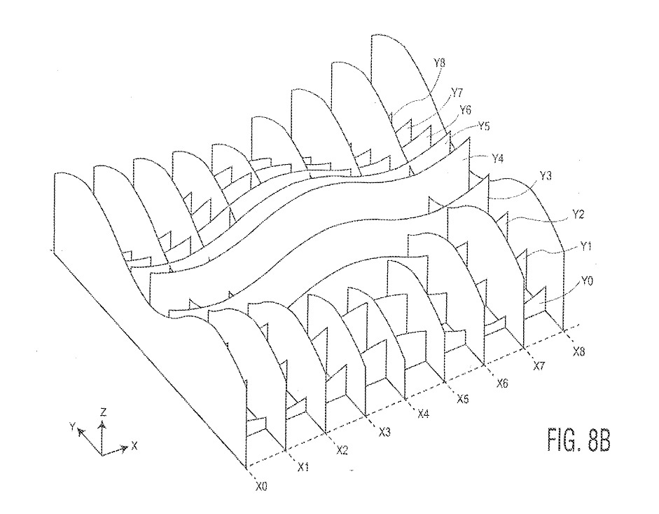

FIG. 8A presents another preferred embodiment of the invention in which the same blade design is used on both axes. Along one axis, the blades rise in elevation as they approach the center of the grid and, along the other axis, the blades decrease in elevation as they approach the center.

FIG. 8B presents still another preferred embodiment of the invention in which blades that have both convex and concave components are used.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. In a cutting device for making a plurality of parallel cuts in a sliceable object when moved toward said object in a cutting direction, said cutting device comprising a plurality of parallel cutting blades each having a leading cutting edge, the improvement wherein leading cutting edge of each cutting blade is non-linear from one end to an opposite end thereof, and wherein the leading cutting edge of each blade has a different elevation in the cutting direction than the leading cutting edges of the blades adjacent thereto, whereby the leading cutting edges of the cutting blades are caused to slice progressively into the sliceable object thereby to reduce the force required to create the parallel cuts through the object.

2. The cutting device recited in claim 1, wherein the leading, cutting edge of each blade is convex in the cutting direction.

3. The cutting device recited in claim wherein the leading cutting edge of each blade is concave in the cutting direction.

4. The cutting device recited in claim 1, wherein the leading cutting edge of at least some of said blades is both concave and convex in the cutting direction.

5. The cutting device′recited in claim 1, comprising two sets of parallel cutting blades, a first set and a second set, with said two sets of blades arranged transversely with respect to each other, thereby to make transverse cuts in the sliceable object.

6. The cutting device recited in claim 1, wherein said two sets of blades form a 90° angle with respect to each other.

7. The cutting device recited in claim 5, wherein the leading cutting edges of the first set of blades are convex in the cutting direction.

8. The cutting device recited in claim 7, wherein the leading cutting edges of the second set of blades are also convex in the cutting direction.

9. The cutting device recited in claim 7, wherein the leading cutting edges of the second set of blades are concave in the cutting direction.

10. The cutting device recited in claim wherein the leading cutting edges of the first set of blades are concave in the cutting direction.

11. The cutting device recited in claim 10, wherein the leading cutting edges of the second set of blades are concave in the cutting direction.

12. The cutting device recited in claim 1, wherein the leading cutting edge of each cutting blade is non-symmetric with respect to a central point between its ends.

13. The cutting device recited in claim 5, wherein the highest elevation of the leading cutting edges in the cutting direction of a first set of blades is greater than the highest elevation of the cutting edges in the cutting direction of the second set of blades, thereby allowing one set of blades to make contact with the sliceable object before contact by the other set to provide a progressive and incremental cutting process.

14. The cutting device recited in claim 1, wherein the leading cutting edge of each cutting blade is symmetric with respect to a central point between its ends.
